(19) United States
(12) Patent Application Publication
(10) Pub. No.: US 2024/0131544 A1
(43) Pub. Date: Apr. 25, 2024

(54) MULTI-CHAMBER FLUID DISPENSER

(71) Applicant: BKB HOLDINGS LLC, Minneapolis, MN (US)

(72) Inventors: Kamal Mohamed, Minneapolis, MN (US); Connor Pelletier-Sutton, Minneapolis, MN (US); Erin Bankson, Minneapolis, MN (US); Sahr Brima, Minneapolis, MN (US); Hamza Muridi, Minneapolis, MN (US); Nabil Ghebre, Burnsville, MN (US)

(21) Appl. No.: 18/279,013

(22) PCT Filed: Feb. 25, 2022
(86) PCT No.: PCT/US2022/018037

§ 371 Date: Aug. 24, 2023

Related U.S. Application Data
(60) Provisional application No. 61/153,704, filed on Feb. 19, 2009.

(51) Int. Cl. B05B 11/00; B05B 11/10; B05B 12/14

(52) U.S. Cl. CPC B05B 11/0038; B05B 11/0078; B05B 11/1084; B05B 12/1409; B65D 1/04

(57) ABSTRACT

Disclosed herein are devices, systems, and methods for dispensing fluids. One general aspect includes a multi-chamber fluid dispenser. The multi-chamber fluid dispenser includes a container and a cap. The container has a plurality of chambers formed therein. Each of the chambers in the plurality of chambers is configured to store fluid therein. The cap is for covering the container. The cap includes a distributor through which fluid stored in any one of the chambers in the plurality of chambers is allowed to be expelled from the container Each of the chambers in the plurality of chambers is configured to be in fluid communication with the dispenser such that fluid is dispensable from the container in at least one of the following manners individually as an individual fluid and together as a mixed fluid.

### CROSS-REFERENCE TO RELATED APPLICATION

This application claims priority to Provisional Application No. 63/153,704, filed Feb. 25, 2021, which is herein incorporated by reference in its entirety.

### FIELD OF THE DISCLOSURE

The present disclosure generally relates to fluid dispensers, and in particular, to fluid dispenser with multiple chambers to hold multiple fluids.

### BACKGROUND

Containing and dispensing liquid, in general, is a task that spans multiple industries. Considering the food, beverage, and hospitality industries, it is generally common for liquid containers to include a reservoir to hold the liquid and measures to dispense the fluid contained in the reservoir. For example, squeeze-, mug-, tumbler-, and pump-type fluid containers typically include a single reservoir or are otherwise ill equipped to conveniently dispense a multi-reservoir contained multiple liquids.

### SUMMARY

Examples disclosed herein provide a variety of advantages over relevant art. For instance, those advantages include: an ability to carry or serve multiple fluids (e.g., sauces or other liquids) with just one hand, an ability to serve multiple fluids (e.g., sauces or other liquids) with just one bottle, and saving space in storage such as in bathrooms, showers, cup holders in cars, and small restaurants with limited space.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 shows various diagrammatic views of a squeeze bottle, according to principles of the present disclosure.

FIG. 2 shows various diagrammatic views of a pump-type bottle, according to principles of the present disclosure.

FIG. 3 shows various diagrammatic views of a mug-type bottle, according to principles of the present disclosure.

Corresponding reference characters indicate corresponding parts throughout the several views. Although the drawings represent embodiments of various features and components according to the present disclosure, the drawings are not necessarily to scale and certain features can be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art can utilize their teachings. It is not beyond the scope of this disclosure to have a number (e.g., all) the features in a given embodiment to be used across all embodiments.

Disclosed herein are devices, systems, and methods for dispensing liquid from a multi-chamber liquid container. By way of example, three specific embodiments employing principles of the present disclosure are disclosed herein. It is intended, and one skilled in the art will appreciate, that each of these examples be applicable in multiple industries, including for instance industries involving restaurants, home, automotive, hospitality, and sports. In general, each of these examples involve an improved dispensing design (e.g., of pumps, caps, etc.) that are intuitive for an end user and employ attachment measures that are easily removable (e.g., via magnets versus screwing) to attach to a container.

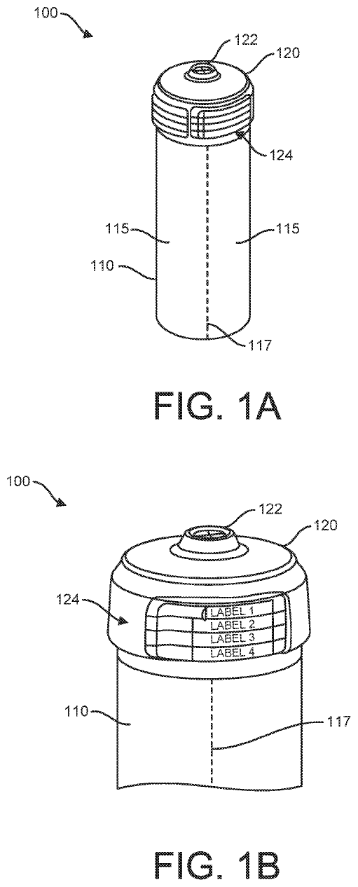

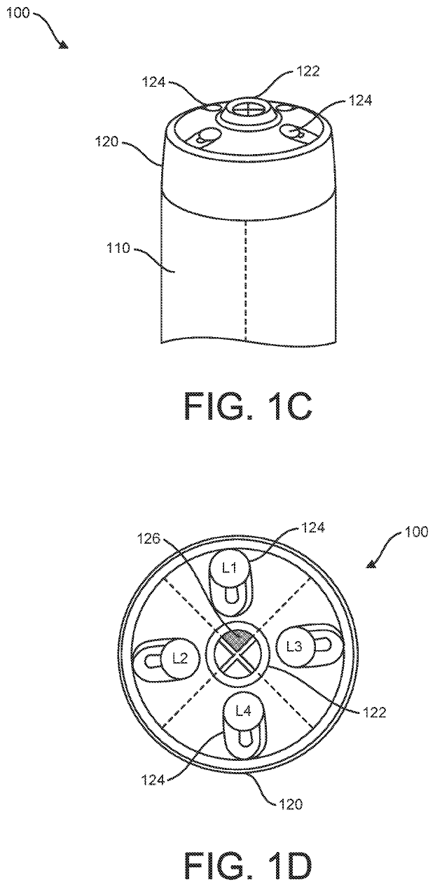

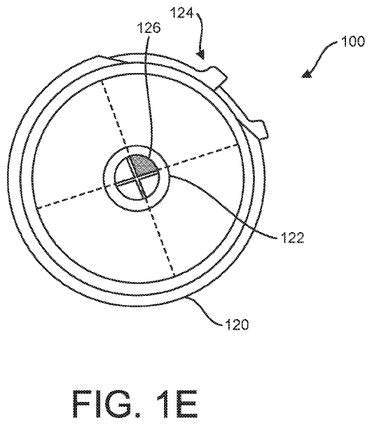

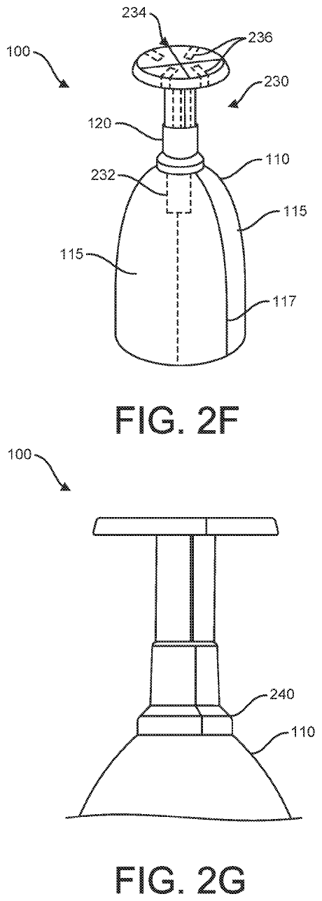

With reference to FIGS. 1-3, one general aspect of the present disclosure includes a multi-chamber fluid dispenser 100 or dispensing system 100. Various views (A-Q) of each illustrated example are also shown. Illustratively, the multi-chamber fluid dispenser 100 includes a container 110 having a plurality of chambers 115 formed therein, each of the chambers 115 in the plurality of chambers 115 being configured to store fluid therein; and a cap 120 for covering the container 110. The cap 120 includes a distributor 122 through which fluid stored in any one of the chambers 115 in the plurality of chambers 115 is allowed to be expelled from the container 110. Each of the chambers 115 in the plurality of chambers 115 is configured to be in fluid communication with the distributor 122 such that fluid is dispensable from the container 110 occurs. Such dispensing can occur in at least one of the following manners: individually as an individual fluid and together as a mixed fluid. Other embodiments of this aspect include corresponding methods, systems, and apparatus, each configured to include this general aspect and to optionally include any or all the specific examples further discussed below.

In a first example, a squeeze bottle that has multiple chambers 115 (e.g., a multi-chamber squeeze bottle 100) is disclosed. In particular, the dispenser 100 can be formed as a squeeze bottle such that at least the container 110 is squeezable. In the illustrated example or FIG. 1, the squeeze bottle includes four chambers 115 to be used, for example, with four different fluids both edible (e.g., sauces) and non-edible (e.g., soaps) fluids. The squeeze bottle has a substantially cylindrical profile. The dispenser 100 may include a selector 124 that is configured to control which of the chambers 115 in the plurality of chambers 115 is allowed to be dispensed from the container 110. The cap 120 includes at least one aperture 126 (e.g., as formed by or as part of the distributor 122 and/or the selector 124) through which the fluid is allowed to be dispensed from the container 110. Each of the apertures in the at least one aperture 126 has a corresponding selector 124 in the at least one selector 124 and a corresponding chamber 115 in the plurality of chambers 115.

Optionally, the plurality of chambers 115 can be integrally or separately formed with the container 110. As shown in FIG. 1, the plurality of chambers 115 is defined by a divider 117 arranged relative to the container 110 to thereby form the plurality of chambers 115. The plurality of chambers 115 includes first and second chambers 115. In examples, the first chamber 115 is fluidly isolated from the second chamber 115. In another example, the first chamber 115 is permeable to the second chamber 115. As is also shown, the divider 117 extends longitudinally within an interior portion of the container 110. As such, the divider 117 extends the length of an interior of the container 110 and may optionally extend into or otherwise interface with the cap 120 to maintain a fluid-tight connection.

Materials used for the container 110 can be silicone, plastic, or the like to allow the container 110 to be squeezed. Internal walls that can form the chamber 115 can be made of similar materials to the container 110. In an example, the internal walls can be made of a more flexible material (e.g., silicone) and that of the outer walls (e.g., plastic). In any of these cases, the container 110 has “give” that allows the end-user to squeeze to collapse the container 110 with enough pressure to squeeze out the sauce or liquid.

Plus, the cap 120 can, as discussed above, be attached via a slide feature that is different from than a typical twist design. Fluid can be dispensed (e.g., via squeezing) from each chamber 115 individually or several (e.g., all) together. As well, the design reduces complexities that exist in traditional designs that employ mechanical measures (e.g., a spring load to push down) to dispense from a specific compartment and reduces waste from using individual packets in order for the spring squeeze design to function properly.

As noted above, dispensing from the container 110 can be controlled via the selector 124. In examples, the selector 124 is formed as at least one selector 124 operatively arranged relative to the cap 120 such that the fluid is allowed to be dispensed through the aperture 126 when the selector 124 is in an open position and fluid is inhibited from being dispensed through the aperture 126 when the selector 124 is in a closed position. In an example, the at least one selector 124 is rotatable relative to the cap 120. (See views B and E.) In another example, the at least one selector 124 is slidable relative to the cap 120. (See views A, C, and D.)

As can be seen in FIG. 1, the cap 120 can be designed to create an intuitive dispensing method. The cap 120 can have a sliding feature to open the nozzles that will dispense the liquid or the sauce for the end-user. The nozzles can inhibit flow of fluid from the container 110 past the cap 120. The cap 120 can include a variety of labels that identify what fluid is in a given chamber 115. The labels can be concealed and revealed via actuation of a label portion of the cap 120. Actuation, for example, can be in the form of a twisting or rotation of the label portion. Unlike traditional designs where caps (e.g., twist dial caps) only allow one sauce to be dispensed at a time and only work with two compartments, the disclosed cap 120 can be designed to dispense one or all (e.g., 2, 3, 4, etc.) sauces/liquids desired by the end-user. This allows both a permutation and combination style dispensing. In addition, having different nozzles allows individual dispensing and prevents cross contamination of the cap 120 with respect to the fluid whereas in traditional designs there is one cap 120 that when opened is exposed to multiple fluids such that the end consumer must dispense multiple fluids at once or do not get to choose either one or all fluids to dispense.

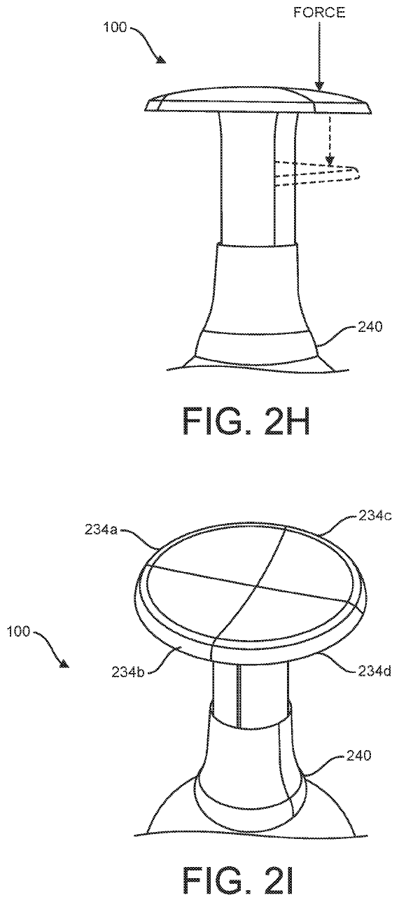

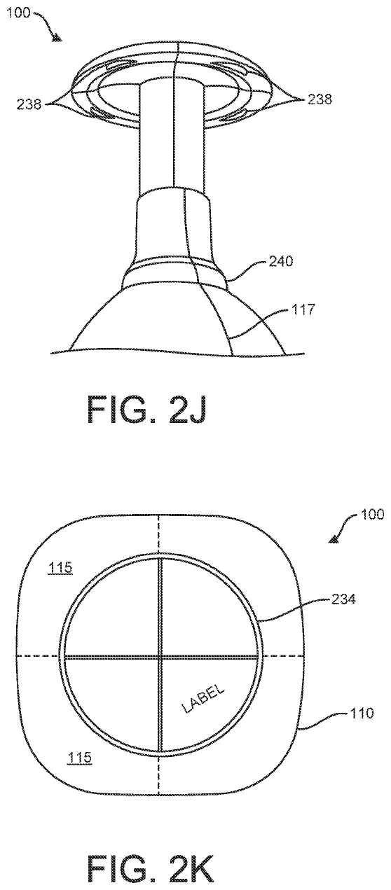

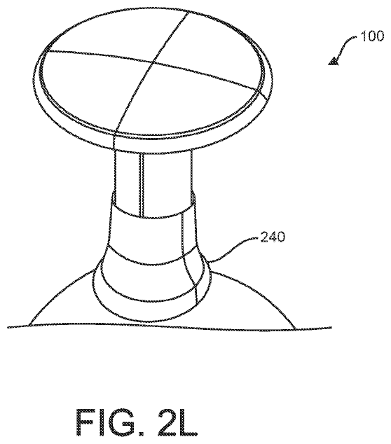

In a second example, as shown in FIG. 2, a pump-type fluid dispenser 100 is disclosed. The second example can be similar to and include all the features of the first example. In this regard, the dispenser 100 may include a pump assembly 230 with which to expel the fluid from the container 110. As shown, the pump assembly 230 includes a pump 232 and a handle 234 with which to actuate the pump 232. The handle 234 can be actuated via application of an external force. (See, e.g., view J.) In some examples, there is a common pump 232 to each chamber 115 while in other examples, there are individual pumps for each chamber 115. In any of these instances, fluid communication between the pump 232 and the chambers 115 can be established via a conduit extending between the pump 232 and the chamber 115.

In general, implementations may include one or more of the following features. The handle 234 may include a plurality of internal passageways 236 corresponding to each chamber 115 in the plurality of chambers 115. The plurality of internal passageways 236 include is in fluid communication with the plurality of chambers 115 such that actuation of the handle 234 dispenses the fluid from at least one of the chambers 115 in the plurality of chambers 115 and out of the container 110 through at least one internal passageway 236 in the plurality of internal passageways 236 (e.g., via apertures or outlets 238). The dispenser 100 may include a collar 240 that is operatively arranged relative to the handle 234 so as to secure the handle 234 to the container 110. The handle 234 is formed from a plurality of complementary handle segments 234a-234d. Each of the handle segments 234a-234d in the plurality of handle segments 234a-234d has an internal passageway 236 of the plurality of internal passageways 236 formed therein.

As shown here, as compared to the first example, the cap 120 is modified to be (e.g., in part or in whole) a pump assembly 230. The pump 232 can be similar to those known in the art except that the nozzle design allows for the ability to dispense four liquids. For example, the pump 232 can include multiple pumping chambers that correspond to each chamber 115 in the container 110. A top portion of the pump 232 can have a smooth curve to ergonomically allow end-user to press down with their digits (e.g., fingers or thumbs) or mechanically via an operatively connected controller (not shown). In examples, the handle 234 can have a generally mushrooming shape comprising handles for each pump 232. The top portion can include a dispensing aperture or outlet 238 positioned underneath a plume of the mushroom shape.

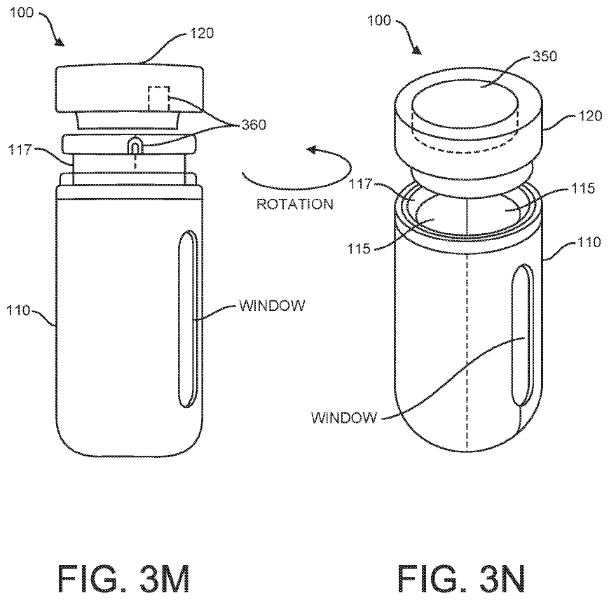

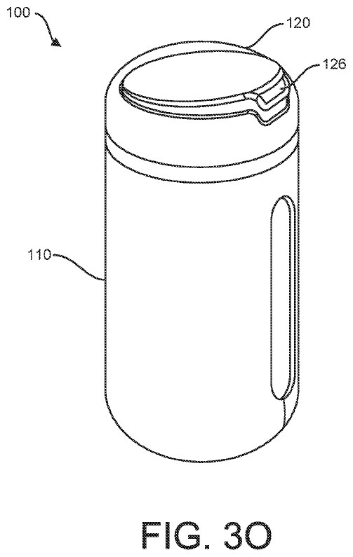

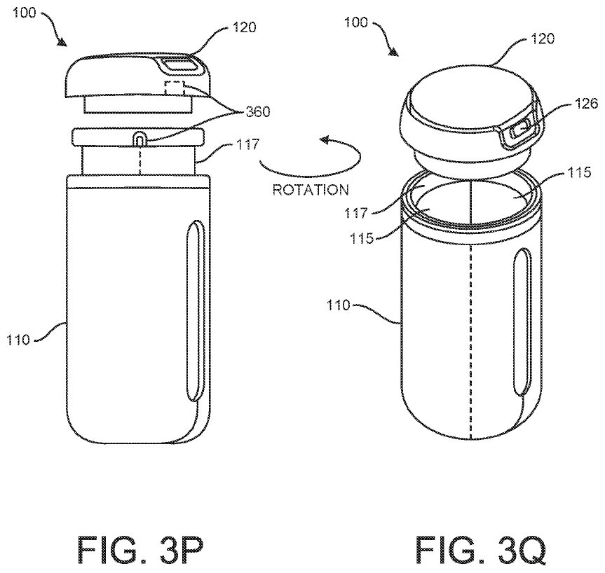

In a third example, as shown in FIG. 3, a mug-type fluid dispenser 100 is disclosed. The third example can be similar to and include all the features of the first and second examples. As shown here, as compared to the first and second examples, the cap 120 is modified to be a lid and the container 110 has two chambers 115. The cap 120 has a storage 350 for the end-user to store materials such as prescriptions, vitamin pills, etc.

As shown here, the dispenser 100 is formed as an insulated container 110. The plurality of chambers 115 is defined by a divider 117 arranged relative to the container 110 to thereby form the plurality of chambers 115. The plurality of chambers 115 includes first and second chambers 115. In examples, the first chamber 115 is fluidly isolated from the second chamber 115. In another example, the first chamber 115 is permeable to the second chamber 115. As is also shown, the divider 117 extends longitudinally within an interior portion of the container 110. As such, the divider 117 extend the length of an interior of the container 110 and may optionally extend into or otherwise interface with the cap 120 to maintain a fluid-tight connection. Dispensing can occur via an aperture 126 that is formed in the cap 120.

The divider 117 is formed as an insert that is receivable within the container 110 and is movably arranged within the container 110 such that movement of the insert corresponds to controlling which of the chambers 115 in the plurality of chambers 115 is allowed to dispense from the container 110. The insert is arranged so as to be rotatably movable within the container 110. The cap 120 is rotatable relative to the container 110 such that rotation of the cap 120 corresponds to rotation of the insert. The cap 120 and the container 110 form an outer profile of the dispenser 100, and where an interface between the cap 120 and the insert includes interlocking features 360 that are internal to the outer profile.

Attachment of the cap 120 to the container 110 can be performed via magnets instead of a traditional twist thread design. This design prevents inadvertent twisting that would misalign the labels, e.g., making it difficult to figure out which side is water and which side is coffee. The magnetic cap 120 will enclose the liquid and make it intuitive on the end-user for the two-sided container 110. In examples, there is a window on both sides of the container 110 to also see the color of the liquid to help the end-user see exactly which liquid it is. Unlike traditional designs where a container 110 stores one main liquid to be combined with a gel or concentrate or powder through permeable membranes, the present disclosure in this example can have a rigid container 110 with chambers 115 that inhibit mixing of stored fluids.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus

While the present disclosure has been described as having an exemplary design, the present invention can be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A multi-chamber fluid dispenser comprising:
a container having a plurality of chambers formed therein, each of the chambers in the plurality of chambers being configured to store fluid therein; and
a cap for covering the container, the cap including a distributor through which fluid stored in any one of the chambers in the plurality of chambers is allowed to be expelled from the container,
wherein each of the chambers in the plurality of chambers is configured to be in fluid communication with the dispenser such that fluid is dispensable from the container in at least one of the following manners: individually as an individual fluid and together as a mixed fluid.

2. The dispenser of claim 1, further comprising a selector that is configured to control which of the chambers in the plurality of chambers is allowed to be dispensed from the container.

3. The dispenser of claim 1, wherein the plurality of chambers is defined by a divider arranged relative to the container to thereby form the plurality of chambers.

4. The dispenser of claim 3, wherein the plurality of chambers includes first and second chambers, and wherein the first chamber is fluidly isolated from the second chamber.

5. The dispenser of claim 3, wherein the divider extends longitudinally within an interior portion of the container.

6. The dispenser of claim 3, wherein the divider is formed as an insert that is receivable within the container and is movably arranged within the container such that movement of the insert corresponds to controlling which of the chambers in the plurality of chambers is allowed to dispense from the container.

7. The dispenser as in claim 1, further comprising a pump assembly with which to expel the fluid from the container.

8. The dispenser of claim 7, further comprising a handle with which to actuate the pump, the handle comprising a plurality of internal passageways corresponding to each chamber in the plurality of chambers, the plurality of internal passageways being in fluid communication with the plurality of chambers such that actuation of the handle dispenses the fluid from at least one of the chambers in the plurality of chambers and out of the container through at least one internal passageway in the plurality of internal passageways.

9. The dispenser of claim 8, further comprising a collar that is operatively arranged relative to the handle so as to secure the handle to the container.

10. The dispenser of claim 8, wherein the handle is formed from a plurality of complementary handle segments, and wherein each of the handle segments in the plurality of handle segments has an internal passageway of the plurality of internal passageways formed therein.

11. The dispenser of claim 6, wherein the insert is arranged so as to be rotatably movable within the container.

12. The dispenser of claim 11, wherein the cap is rotatable relative to the container such that rotation of the cap corresponds to rotation of the insert.

13. The dispenser of claim 2, wherein cap includes at least one aperture through which the fluid is allowed to be dispensed from the container, and wherein the selector is formed as at least one selector operatively arranged relative to the cap such that the fluid is allowed to be dispensed through the aperture when the selector is in an open position and fluid is inhibited from being dispensed through the aperture when the selector is in a closed position.

14. The dispenser of claim 13, wherein each of the apertures in the at least one aperture has a corresponding selector in the at least one selector and a corresponding chamber in the plurality of chambers.

15. The dispenser of claim 13, wherein the at least one selector is rotatable relative to the cap.

16. The dispenser of claim 13, wherein the at least one selector is slidable relative to the cap.

17. The dispenser of claim 12, wherein the cap and the container form an outer profile of the dispenser, and wherein an interface between the cap and the insert includes an interlocking feature that is internal to the outer profile.

18. The dispenser as in claim 1, wherein the dispenser is formed as a squeeze bottle such that at least the container is squeezable.

19. The dispenser of claim 18, wherein the squeeze bottle has a substantially cylindrical profile.

20. The dispenser as in claim 1, wherein the dispenser is formed as an insulated container.
